(19) United States
(12) Patent Application Publication
(10) Pub. No.: US 2015/0039612 A1
(43) Pub. Date: Feb. 5, 2015

(54) STORAGE-BASED DATA ANALYTICS KNOWLEDGE MANAGEMENT SYSTEM

(71) Applicant: LHSG Co., Seoul (KR)

(72) Inventors: Hun Lee, Seoul (KR); Jeong A. Kang, Seoul (KR)

(73) Assignee: LHSG Co., Seoul (KR)

(21) Appl. No.: 13/959,110

(22) Filed: Aug. 5, 2013

(51) Int. Cl. G06F 17/30

(52) U.S. Cl. CPC G06F 17/30312; G06F 17/30598
USPC 707/737

(57) ABSTRACT

Aspects of the present invention provide a solution for augmenting managed data. In an embodiment, a data item that is being and/or has been accessed by a user is analyzed to retrieve a set of features. Based on this set of features, the data item is indexed. An analytical analysis is performed on the data item based on the set of features. This analytical analysis can be used to obtain a group of data items that is related to the data item. This group of related data items can be returned to the user, such as when the user reacquires network connectivity.

### TECHNICAL FIELD

The subject matter of this invention relates generally to data management. More specifically, aspects of the present invention provide a solution for enhancing managed data using analytics.

### BACKGROUND

As information technology has developed, the amount of data available for retrieval has increased dramatically. At its core, this data is often stored in one or more storage systems and retrieved using one of a variety of solutions. These storage systems have developed from simple solutions that serve a single machine to vast storage repositories that provide storage for large networks of computers. The complexities of these storage systems often continue to grow over time, with new data and/or data structures being added constantly.

This evolution of storage systems has precipitated a parallel development in the logic used to manage the data therein. These management strategies usually require a user to obtain, manipulate and/or forward a particular data item. However, the increasing amount of data combined with the complexities of the underlying storage systems can result in a user never having seen meaningful data that is related to the managed data item. This is particularly true in cases in which network connectivity is limited.

### SUMMARY

In general, aspects of the present invention provide a solution for augmenting managed data. In an embodiment, a data item that is being and/or has been accessed by a user is analyzed to retrieve a set of features. Based on this set of features, the data item is indexed. An analytical analysis is performed on the data item based on the set of features. This analytical analysis can be used to obtain a group of data items that is related to the data item. This group of related data items can be returned to the user, such as when the user reacquires network connectivity.

A first aspect of the invention provides a computer-implemented method for augmenting managed data, comprising: examining a data item accessed by a user to retrieve a set of features; indexing the data item based on the set of features; analyzing the set of features from the indexing to obtain a group of related data items; and returning the group of related data items to the user.

A second aspect of the invention provides a system for augmenting managed data, comprising at least one computer device that performs a method, comprising: examining a data item accessed by a user to retrieve a set of features; indexing the data item based on the set of features; analyzing the set of features from the indexing to obtain a group of related data items; and returning the group of related data items to the user.

A third aspect of the invention provides a computer program product stored on a computer readable storage medium, which, when executed, performs a method for augmenting managed data, comprising: examining a data item accessed by a user to retrieve a set of features; indexing the data item based on the set of features; analyzing the set of features from the indexing to obtain a group of related data items; and returning the group of related data items to the user.

A fourth aspect of the invention provides a method for deploying an application for augmenting managed data, comprising: providing a computer infrastructure being operable to: analyze examining a data item accessed by a user to retrieve a set of features; indexing the data item based on the set of features; analyzing the set of features from the indexing to obtain a group of related data items; and returning the group of related data items to the user.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an illustrative computer system according to embodiments of the present invention.

FIG. 2 shows a data network according to embodiments of the invention.

FIG. 3 shows an example graphical representation of a pattern profile comparison according to embodiments of the invention.

FIG. 4 shows an example flow diagram according to embodiments of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments will now be described more fully herein with reference to the accompanying drawings, in which embodiments are shown. This disclosure may, however, be embodied in many different forms and should not be construed as limited to the embodiments set forth herein. Rather, these embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

The inventors of the invention described herein have discovered certain deficiencies in the current solutions for management of data items provided to a user. For example, currently, most data items are provided to a user based on an inquiry, search, collection, etc., that is initiated by the user. In these solutions, if a user desires further information regarding the data item, he or she must initiate another operation to acquire the data items that may be related. However, such further attempts may be hindered by a number of factors. Any acquisition attempt by the user necessarily requires that the user dedicate time, which could be otherwise spent, to data acquisition. Further, the amount of time that must be dedicated depends on the efficiency of the user in acquiring the related data, resulting in increased time and frustration for inefficient users. Still further, such active acquisition attempts require the user to maintain a constant connection with the repository or repositories in which the related data resides.

As indicated above, aspects of the present invention provide a solution for augmenting managed data. In an embodiment, a data item that is being and/or has been accessed by a user is analyzed to retrieve a set of features. Based on this set of features, the data item is indexed. An analytical analysis is performed on the data item based on the set of features. This analytical analysis can be used to obtain a group of data items that are related to the data item. This group of related data items can be returned to the user (i.e., when the user reacquires network connectivity).

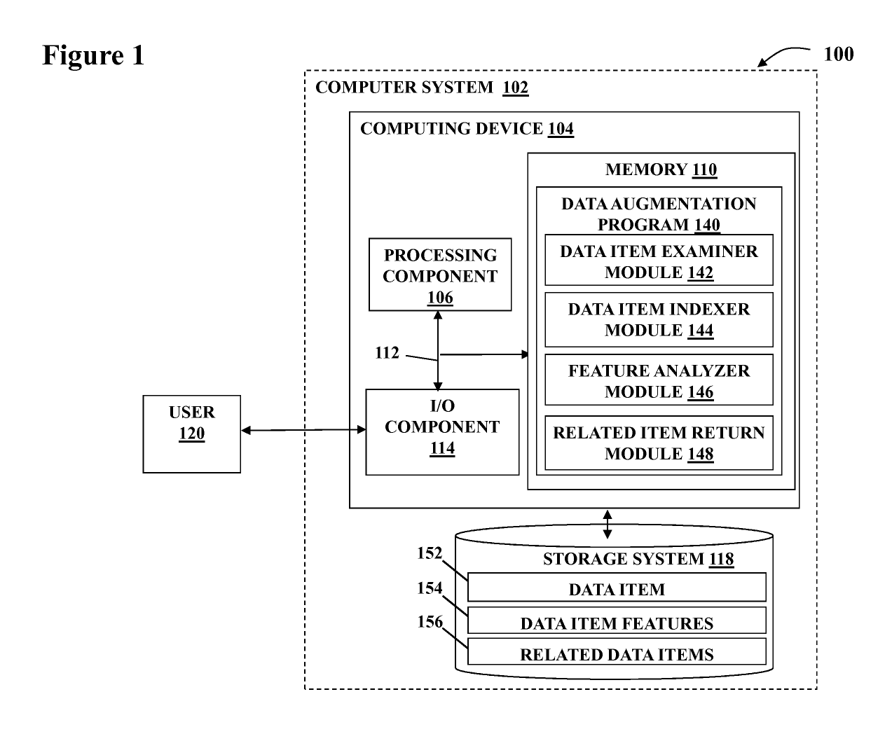

Referring now to the drawings, FIG. 1 shows an illustrative environment 100 for augmenting managed data. To this extent, environment 100 includes a computer system 102 that can perform a process described herein in order to augment managed data. In particular, computer system 102 is shown including a computing device 104 that includes a data augmentation program 140, which makes computing device 104 operable to augment managed data by performing a process described herein.

Computing device 104 is shown including a processing component 106 (e.g., one or more processors), a memory 110, a storage system 118 (e.g., a storage hierarchy), an input/output (I/O) component 114 (e.g., one or more I/O interfaces and/or devices), and a communications pathway 112. In general, processing component 106 executes program code, such as data augmentation program 140, which is at least partially fixed in memory 110. To this extent, processing component 106 may comprise a single processing unit, or be distributed across one or more processing units in one or more locations.

Memory 110 also can include local memory, employed during actual execution of the program code, bulk storage (storage 118), and/or cache memories (not shown), which provide temporary storage of at least some program, code in order to reduce the number of times code must be retrieved from storage system 118 during execution. As such, memory 110 may comprise any known type of temporary or permanent data storage media, including magnetic media, optical media, random access memory (RAM), read-only memory (ROM), a data cache, a data object, etc. Moreover, similar to processing component 106, memory 110 may reside at a single physical location, comprising one or more types of data storage, or be distributed across a plurality of physical systems in various forms.

While executing program code, processing component 106 can process data, which can result in reading and/or writing transformed data from/to memory 110 and/or I/O component 114 for further processing. Pathway 112 provides a direct or indirect communications link between each of the components in computer system 102. I/O component 114 can comprise one or more human I/O devices, which enable a human user 120 to interact with computer system 102 and/or one or more communications devices to enable a system user 120 to communicate with computer system 102 using any type of communications link.

To this extent, data augmentation program 140 can manage a set of interfaces (e.g., graphical user interface(s), application program interface, and/or the like) that enable human and/or system users 120 to interact with data augmentation program 140. Users 120 could include system administrators and/or clients who need to store and/or augment managed data in a storage system environment, among others. Further, data augmentation program 140 can manage (e.g., store, retrieve, create, manipulate, organize, present, etc.) the data in storage system 118, including, but not limited to a data item 152, data item features 154, and/or related data items 156, using any solution.

In any event, computer system 102 can comprise one or more computing devices 104 (e.g., general purpose computing articles of manufacture) capable of executing program code, such as data augmentation program 140, installed thereon. As used herein, it is understood that “program code” means any collection of instructions, in any language, code or notation, that cause a computing device having an information processing capability to perform a particular action either directly or after any combination of the following: (a) conversion to another language, code, or notation; (b) reproduction in a different material form; and/or (c) decompression. To this extent, data augmentation program 140 can be embodied as any combination of system software and/or application software. In any event, the technical effect of computer system 102 is to provide processing instructions to computing device 104 in order to augment managed data.

Further, data augmentation program 140 can be implemented using a set of modules 142-148. In this case, one or more modules 142-148 can enable computer system 102 to perform a set of tasks used by data augmentation program 140, and can be separately developed and/or implemented apart from other portions of data augmentation program 140. As used herein, the term “component” means any configuration of hardware, with or without software, which implements the functionality described in conjunction therewith using any solution, while the term “module” means program code that enables a computer system 102 to implement the actions described in conjunction therewith using any solution. When fixed in a memory 110 of a computer system 102 that includes a processing component 106, a module is a substantial portion of a component that implements the actions. Regardless, it is understood that two or more components, modules, and/or systems may share some/all of their respective hardware and/or software. Further, it is understood that some of the functionality discussed herein may not be implemented or additional functionality may be included as part of computer system 102.

When computer system 102 comprises multiple computing devices 104, each computing device 104 can have only a portion of data augmentation program 140 fixed thereon (e.g., one or more modules 142-148). However, it is understood that computer system 102 and data augmentation program 140 are only representative of various possible equivalent computer systems that may perform a process described herein. To this extent, in other embodiments, the functionality provided by computer system 102 and data augmentation program 140 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 102 includes multiple computing devices 104, the computing devices can communicate over any type of communications link. Further, while performing a process described herein, computer system 102 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

As discussed herein, data augmentation program 140 enables computer system 102 to augment managed data. To this extent, data augmentation program 140 is shown including a data item examiner module 142, a data item indexer module 144, a feature analyzer module 146, and a related item return module 148.

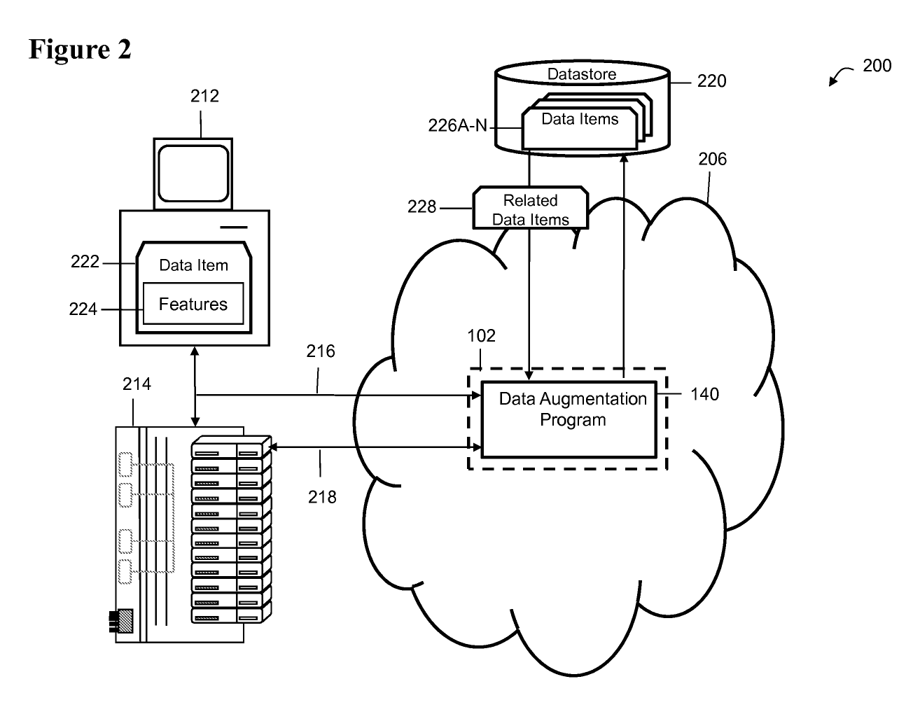

Referring now to FIG. 2, a system diagram 200 describing the functionality discussed herein according to an embodiment of the present invention is shown. It is understood that the teachings recited herein may be practiced within any type of networked computing environment 206 (e.g., a cloud computing environment). In the event the teachings recited herein are practiced in a networked computing environment 206, each client 212 need not have a data augmentation program (hereinafter “system 140”). Rather, all or a portion of system 140 could be practiced on a server or server-capable device that communicates 216 (e.g., wirelessly) with the clients 212 to provide device protection therefor. Additionally, or in the alternative, all or a portion of system 140 could be loaded on the client 212 itself, on a server 214 that the client 212 uses to connect 218 to the networked computing environment or a combination thereof. Regardless, as depicted, system 140 is shown within computer system/server 102. In general, system 140 can be implemented as program/utility 140 on computer system 102 of FIG. 1 and can enable the functions recited herein. It is further understood that system 140 may be incorporated within or work in conjunction with any type of system that receives, processes, and/or executes commands with respect to IT resources in a networked computing environment. Such other system(s) have not been shown in FIG. 2 for brevity purposes.

Along these lines, system 140 may perform multiple functions similar to a general-purpose computer. Specifically, among other functions, system 140 can augment managed data for a user 120 (FIG. 1) (e.g., that uses a client 212 to access a data item 222 in networked computing environment 206). To this extent, client 212 can include a desktop or laptop computer, a tablet, smart phone, personal digital assistant (pda), and/or any other device now known or later developed that is capable of accessing a data item 222 in a networked computing environment.

Referring now to FIG. 2 in conjunction with FIG. 1, data item examiner module 142, as executed by computer system 102, examines a data item 222 accessed by a user 120. Data item examiner module 142 can examine a data item 222 that is currently being accessed by a user, such as data that is being viewed, listened to, manipulated, downloaded, imported, acquired, and/or accessed in any other manner (e.g., on client 212). For example, the examination can occur in response to acquisition of a data item 222, opening of a data item 222 on client 212 by user 120, user 120 creating and/or making a change to data item 222 and/or the like. In the alternative, data item examiner module 142 can perform the examination at a point in time during which the user 120 is not directly accessing the data item 222. To this extent, whether the examination is performed while the user is directly accessing the data item or not, the examination and/or other processes performed by data augmentation program 140 can be performed in the background (e.g., without the need for any action and/or intervention on the part of the user 120). In any case, data item 222 can include any classification/type of data in any format that is accessible by a user 120 (e.g., using a client 212). For example, data item 222 can include, but not be limited to, a web page, an email, text, a table, a spreadsheet, a photograph, audio data, video data, a query result, and/or the like.

Whatever the case, the examination performed by data item examiner module 142 can be used to retrieve a set of one or more features 224 of the data item 222. In general, features 224 thus retrieved can reflect informational content of the data item 222, as opposed to merely descriptive data, such as file size, file type, file location, data types, and/or the like. To this extent, data item examiner module 142 can use any solution now known or later developed to retrieve the set of features 224 and/or can vary the solution or solutions based on the type of data included in the data item 222. For example, in the case of textual data, data item examiner module 142 can employ a parser to extract features 224 that include words and/or phrases that indicate the subject matter of the data item 222. Additionally, or in the alternative, in the case of web pages and other web-based data, data item examiner 142 can analyze metatags and/or other metadata to extract subject matter indicative of features 224. Still further, in the case of photographic data (e.g., from a website, imported by the user 120 using a digital camera, or the like), features 224 can be extracted via image recognition technology used to identify images in the photograph, optical character recognition (ocr) to identify and convert writing in the photo, and/or the like. Features 224 can be extracted from audio data based on music pattern and/or voice recognition, and these solutions, as well as those applied to photographic data, can also be used to extract features 224 from video data. The above examples are intended to be illustrative and not limiting and it should be understood by those skilled in the art that any analysis solution now known or later developed is envisioned.

In any event, all or part of the functions performed by data item examiner module 142 can be performed at the client 212, in networked computing environment 206 and/or on server 214. For example, after data item 222 arrives on the client 212, client data item examiner module 142 can execute on client 212 to perform some or all of the examination of data item 222 and/or the extraction of features 224 from data item 222. Results of the examination and/or features 224 can then be uploaded to networked computing environment 206 and/or server 214 for further processing, as will be described herein. In the alternative, data item 222 itself can be stored during download from networked computing environment 206 and/or uploaded from client 212 to networked computing environment 206 and/or server 214. In this case, server 214 and/or client examiner module 142 can perform all or a portion of its functions on the networked computing environment 206 and/or server 214.

Data item indexer module 144, as executed by computer system 102, indexes the data item 222 based on the set of features 224. All or a portion of the indexing can be performed on the client 212, on networked computing environment 206, and/or on server 214. In any case, the indexing performed by data item indexer module 144 can be performed using any solution now known or later developed for optimizing speed and/or performance in finding related data items 228. To this extent, data item indexer module 144 can utilize interdisciplinary concepts from such fields as linguistics, cognitive psychology, mathematics, informatics, physics, computer science, and/or the like. As such, data item indexer module 144 can incorporate features 224 into an index of data item 222 can reflect the informational content of the data item 222. The resulting indexed data item 222 and can be more easily searched for informational content and/or compared against similarly indexed data items 226A-N. Further, in the case in which client 212 becomes disassociated with computing environment 206, analysis (as will be described herein) of data item 222 can be performed with regard to data items 226A-N even though the exact data item 222 may not be currently accessible. Further, at the point in time that client 212 becomes reassociated with computing environment 206, the indexing allows the results of the analysis from computing environment 206 to be more easily synchronized with client 212.

Feature analyzer module 146, as executed by computer system 102, analyzes the set of features 224 from the indexing performed by data item indexer module 144. This analyzing can be based on such factors that are particular to the user 120 as personal information of the user 120, log files associated with the user 120, preferences of user 120, a search history corresponding to the user and/or the like. These factors can be retrieved from storage on client 212, networked computing environment 206, server 214, and/or elsewhere and used to perform the analysis.

To this extent, the analysis performed by feature analyzer module 146 can be used to generate a pattern profile of the data item based on the set of features. This pattern profile can also include the factors that are particular to the user 120. Such an augmented pattern profile can enable the subsequent search for related data items 228 to more closely anticipate information that the user would find more desirable. In any case, the pattern profile thus generated can be compared with previously computed pattern profiles corresponding to other data items 226A-N. Based on this comparison, the similarity between the pattern profile corresponding to the data item 222 can be computed with respect to each of the plurality of previously computed pattern profiles associated with the other data items 226A-N.

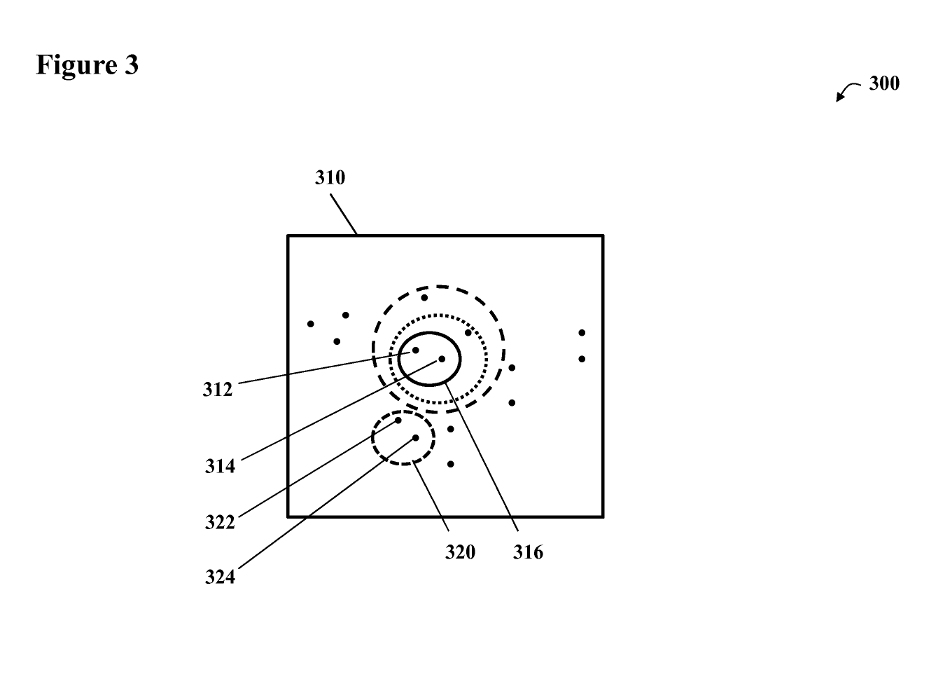

Referring now to FIG. 3, a graphical representation 300 that can be used to compare a pattern profile with a set of other pattern profiles according to embodiments of the invention is shown. As illustrated, in conjunction with FIGS. 1 and 2, a number of data points that represent pattern profiles have been represented as a graph 310. Assume that starting data point 312 represents a pattern profile that the user desires to compare against (e.g., a pattern profile corresponding to data item 222). Starting data point 312 can be associated with 316 with a next proximate data point 314 that is associated with a previously gathered pattern profile. This associating of the starting data point can be repeatedly performed with each of a series of next proximate previously generated pattern profiles on the graph 310, as illustrated by the larger circles illustrating the associations. In contrast, an unrelated association 320 to association 316 indicates that a comparison between data points 322 and 324 results in a determination that the pattern profiles that are associated with these two data points 322 and 324 are related to each other but not to starting data point 312. It should be understood that graphical representation 300 is not meant to be limiting. Rather, any solution for data comparison of features 224 of a data item 222 with those of other data items 226A-N that is now known or later developed is envisioned. Further, in the case that a solution akin to the graphical representation 300 is used, it should be understood that graphical representation is not limited to two dimensions. Rather, three or more dimensional solutions are also envisioned.

Based on these associations, each of other data items 226A-N that correspond to an associated proximate pattern profile can be ranked based on proximity to the pattern profile associated with the data item 222. A group of related data items 228 can be compiled based on this ranking.

Referring again to FIGS. 1 and 2, related item return module 148, as executed by computer system 102, returns the related data items 228 obtained by feature analyzer module 146 to the user 120. These related data items 228 can be returned to the user 120 immediately upon retrieval, such as in the case that the client 212 is continuously connected to networked computing environment 206. In the alternative, feature analyzer module 146 can delay returning the related data items 228. For example, in cases in which the client 212 is not continuously connected with networked computing environment 206, related item return module 148 can return the related data items 228 in response to the client reassociating with the networked computing environment. This delayed returning of the related data items can allow processing to be performed independently of any association of the client 212 with the networked computing environment 206. In addition, the distributed nature of system 140 can allow the process to be performed by any or all of the client 212, the networked environment 206, the server 214, etc., while they are disassociated from one another and the results to be synchronized upon reassociation.

For example, a user 212 can associate the client 212 with the networked computing environment 206, such as by logging into the networked environment 206 (e.g., via the server 214). While associated with networked computing environment 206, the user 120 can acquire the data item 222 on the client 212 over networked computing environment 206 (e.g., from a datastore 220). The data item 222 and/or information regarding whichever portions of the examination and/or the indexing which are to be performed on the client 212 can then be uploaded from the client to at least one of the networked computing environment 206 and/or the server 214. Any portion of the examination and/or the indexing that were not performed on the client 212, as well as all or a portion of the analyzing, can be performed on the networked computing environment 206 and/or the server 214.

To this extent, the processing that is performed on the networked computing environment 206 (e.g., examination, indexing, and/or analysis) can be performed independently of whether the client 212 is currently associated with networked computing environment 206. This allows a user 120 to disassociate the client 212 from the networked computing environment 206 for a time during which networked computing environment 206 performs at least a portion of the analyzing and to return the related data items 228 to the client 212 when the user 120 reassociates the client 212 with the networked computing environment 206. This processing could be further distributed to augment the data item 222 over a plurality of disassociation/reassociation iterations. In this case, the client 212 and the networked computing environment 206 could independently perform incremental portions of the processing (e.g., examining, indexing, analyzing, etc.). The client 212 and networked computing environment can be synchronized each time the client 212 is reassociated with the networked computing environment 206. During such synchronization events, the client can upload results of the operations performed on the client to the networked computing environment 206. Additionally, or in the alternative, the networked computing environment 206 can download one or more related data items 228 from the results of the analysis.

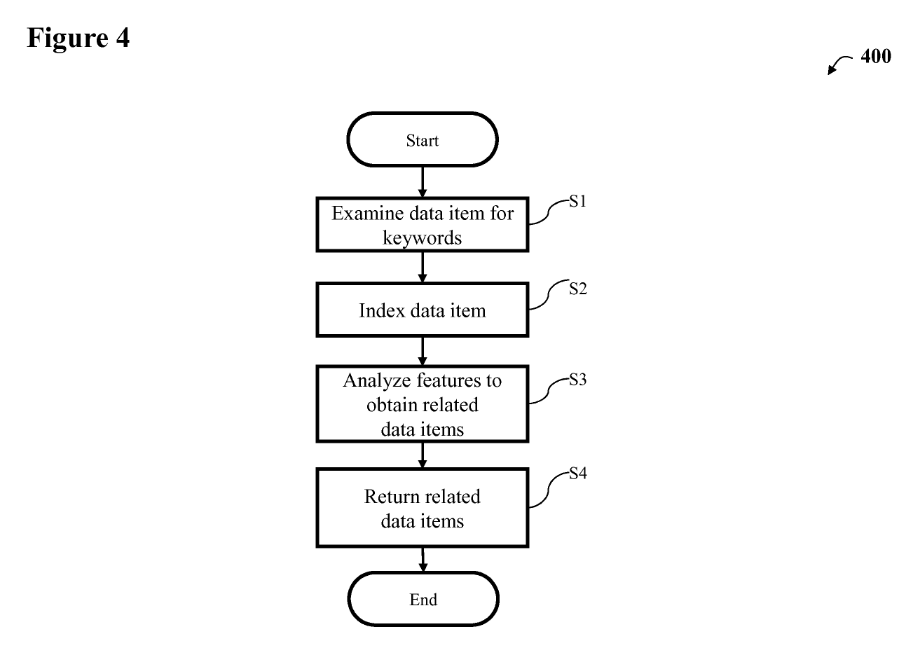

Turning now to FIG. 4, an example flow diagram 400 according to embodiments of the invention is shown. As illustrated in FIG. 4 in conjunction with FIGS. 1 and 2, in 51, data item examiner module 142, as executed by computer system 102, examines a data item 222 to retrieve a set of features 224. This set of features 224 can, for example, include any aspect of the data item 222 that conveys the informational content of the data item 222. In S2, data item indexer module 144, as executed by computer system 102, indexes the data item 222 based on set of features 224. In S3, feature analyzer module 146, as executed by computer system 102, analyzes the set of features 224 from the indexing to obtain a group of related data items 228. In S4, related item return module 148, as executed by computer system 102, returns the group of related data items 228 to the user.

While shown and described herein as a method and system for augmenting managed data, it is understood that aspects of the invention further provide various alternative embodiments. For example, in one embodiment, the invention provides a computer program fixed in at least one computer-readable medium, which, when executed, enables a computer system to augment managed data. To this extent, the computer-readable medium includes program code, such as data augmentation program 140 (FIG. 1), which implements some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; and/or the like.

In another embodiment, the invention provides a method of providing a copy of program code, such as data augmentation program 140 (FIG. 1), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for augmenting managed data. In this case, a computer system, such as computer system 120 (FIG. 1), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like.

The terms “first,” “second,” and the like, if and where used herein, do not denote any order, quantity, or importance, but rather are used to distinguish one element from another, and the terms “a” and “an” herein do not denote a limitation of quantity, but rather denote the presence of at least one of the referenced item. The modifier “approximately”, where used in connection with a quantity is inclusive of the stated value and has the meaning dictated by the context (e.g., includes the degree of error associated with measurement of the particular quantity). The suffix “(s)” as used herein is intended to include both the singular and the plural of the term that it modifies, thereby including one or more of that term (e.g., the metal(s) includes one or more metals).

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A computer-implemented method for augmenting managed data, comprising:
examining a data item accessed by a user to retrieve a set of features;
indexing the data item based on the set of features;
analyzing the set of features from the indexing to obtain a group of related data items; and
returning the group of related data items to the user.

2. The computer-implemented method of claim 1, further comprising:
acquiring the data item on a client associated with the user over a network;
disassociating the client from the network subsequent to the acquiring;
performing at least a portion of the analyzing on at least one computer system in the network while the client is disassociated from the network;
reassociating the client with the network; and
carrying out the returning of the group of related data items to the client in response to the reassociating.

3. The computer-implemented method of claim 2, further comprising:
uploading the data item from the client to at least one computer system on the network prior to the disassociating; and
performing at least a portion of the examining and the indexing on the at least one computer system while the client is disassociated from the network.

4. The computer-implemented method of claim 2, further comprising:
performing at least a portion of at least one of the examining or the indexing on the client;
uploading results of operations performed on the client to the at least one computer; and
performing the analyzing on the at least one computer based on the results.

5. The computer-implemented method of claim 1, the analyzing further comprising:
generating a pattern profile of the data item based on the set of features;
computing a similarity of the pattern profile of the data item and a plurality of previously computed pattern profiles associated with other data items;
associating the pattern profile with a most proximate previously computed pattern profile;
repeatedly associating the pattern profile with each of a series of next proximate previously computer pattern profiles;
ranking each of the other data items that corresponds to an associated proximate pattern profile based on proximity to the pattern profile; and
compiling the group of related data items based on the ranking.

6. The computer-implemented method of claim 1, wherein the analyzing is performed based on personal information of the user and history data of the user.

7. A system for augmenting managed data, comprising at least one computer device that performs a method, comprising:
examining a data item accessed by a user to retrieve a set of features;
indexing the data item based on the set of features;
analyzing the set of features from the indexing to obtain a group of related data items; and
returning the group of related data items to the user.

8. The system of claim 7, the method further comprising:
acquiring the data item on a client associated with the user over a network;
disassociating the client from the network subsequent to the acquiring;
performing at least a portion of the analyzing on at least one computer system in the network while the client is disassociated from the network;
reassociating the client with the network; and
carrying out the returning of the group of related data items to the client in response to the reassociating.

9. The system of claim 8, the method further comprising:
uploading the data item from the client to at least one computer system on the network prior to the disassociating; and
performing at least a portion of the examining and the indexing on the at least one computer system while the client is disassociated from the network.

10. The system of claim 8, the method further comprising:
performing at least a portion of at least one of the examining or the indexing on the client;
uploading results of operations performed on the client to the at least one computer; and
performing the analyzing on the at least one computer based on the results.

11. The system of claim 7, the analyzing further comprising:
generating a pattern profile of the data item based on the set of features;
computing a similarity of the pattern profile of the data item and a plurality of previously computed pattern profiles associated with other data items;
associating the pattern profile with a most proximate previously computed pattern profile;
repeatedly associating the pattern profile with each of a series of next proximate previously computer pattern profiles;
ranking each of the other data items that corresponds to an associated proximate pattern profile based on proximity to the pattern profile; and
compiling the group of related data items based on the ranking.

12. The system of claim 7, wherein the analyzing is performed based on personal information of the user and history data of the user.

13. A computer program product stored on a computer readable storage medium, which, when executed, performs a method for augmenting managed data, comprising:
examining a data item accessed by a user to retrieve a set of features;
indexing the data item based on the set of features;
analyzing the set of features from the indexing to obtain a group of related data items; and
returning the group of related data items to the user.

14. The program product of claim 13, the method further comprising:
acquiring the data item on a client associated with the user over a network;
disassociating the client from the network subsequent to the acquiring;
performing at least a portion of the analyzing on at least one computer system in the network while the client is disassociated from the network;
reassociating the client with the network; and
carrying out the returning of the group of related data items to the client in response to the reassociating.

15. The program product of claim 14, the method further comprising:
uploading the data item from the client to at least one computer system on the network prior to the disassociating; and
performing at least a portion of the examining and the indexing on the at least one computer system while the client is disassociated from the network.

16. The program product of claim 14, the method further comprising:
performing at least a portion of at least one of the examining or the indexing on the client;
uploading results of operations performed on the client to the at least one computer; and
performing the analyzing on the at least one computer based on the results.

17. The program product of claim 13, the analyzing further comprising:
generating a pattern profile of the data item based on the set of features;
computing a similarity of the pattern profile of the data item and a plurality of previously computed pattern profiles associated with other data items;
associating the pattern profile with a most proximate previously computed pattern profile;
repeatedly associating the pattern profile with each of a series of next proximate previously computer pattern profiles;
ranking each of the other data items that corresponds to an associated proximate pattern profile based on proximity to the pattern profile; and
compiling the group of related data items based on the ranking.

18. The program product of claim 13, wherein the analyzing is performed based on personal information of the user and history data of the user.
